(19) United States
(12) Patent Application Publication
(10) Pub. No.: US 2009/0076726 A1
(43) Pub. Date: Mar. 19, 2009

(54) Transmission line data acquisition system

(76) Inventors: Joseph A. Gemignani, JR., Cedarburg, WI (US); Jeffrey D. Young, Wheaton, IL (US)

Correspondence Address: Joseph A. Gemignani, Sr., 616 East Day Avenue, Whitefish Bay, WI, 53217, US

(21) Appl. No.: 12/220,229

(22) Filed: Jul. 23, 2008

Related U.S. Application Data
(60) Provisional application No. 60/961,882, filed on Jul. 25, 2007.

(51) Int. Cl. G01C 21/00; G06F 3/041

(52) U.S. Cl. 701/213; 715/702; 715/771; 715/784; 715/727

(57) ABSTRACT

Acquiring structural defects and vegetation conditions on electric transmission lines and the right of way a touch screen laptop including memory capability associated with a GPS unit. Operating the laptop off of store geographic coordinates of structures and acquiring such coordinates when desired. The touch screen has buttons corresponding to the conditions for entry to memory a record of conditions corresponding to that ascribed to the button. Capturing a structure for data entry when a preselected distance exists between the laptop and a structure and further programmed to enter into memory any condition entries through the touch screen, releasing when the distance is exceeded, and recording to memory all entries made during capture. Photos can be taken of a condition and a voice note can be generated for a condition, both being recorded in memory with condition entries and all indexed to the captured structure. The serial capture and release is paused to maintain the capture of a particular structure beyond the preselected distance is exceeded and stays on the currently captured structure. The system can accommodate single circuit lines and multiple circuit lines. The system can capture a voice note and a still photo relating to and of the condition detected and store in association with the entered defect. The system also includes the capability of locating support structures as in a survey through the operation to the laptop by the observer. The system will report to any asset management media.

### CROSS REFERENCE TO RELATED APPLICATIONS

This application claims the benefit of the filing date of the earlier filed Provisional Application Ser. No. 60/961,882 filed Jul. 25, 2007 and entitled “Transmission Line Data Acquisition system”.

### TECHNICAL FIELD

This invention is the field of inspection of electric power lines, specifically transmission but also distribution lines, and maintenance of the reliability and integrity of the electric transmission grid system. It relates to a system for acquiring data relating to defects in the support structures, electrical lines and equipment on the support structures of the electric transmission lines, and also relating to problematic vegetation situations and other possible encroachments along the transmission line right of way which could degrade the grid system. Further it relates to a system for providing survey data (geographic coordinates, longitude and latitude) of support structures in the grid as well as other structural components of the grid.

### BACKGROUND OF THE INVENTION

Electric transmission and distribution lines require periodic patrol and, as needed, maintenance to insure the integrity of the electric grid and reliable delivery of electricity to the retail customer, residential and commercial.

Patrol covers a number of areas, the condition of the grid conductors, the condition of the support structures (metal towers, wood poles and the like), the condition of the electrical equipment suspended on the support structures and tied to the conductors, the condition of connections of the conductors to the electrical equipment and associated hardware, vegetation management where encroachment by trees, plants, brush and the like is monitored, and generally the condition of the right of way along which the conductors are strung and in which the support structures are positioned.

Commonly patrol is carried out from the air or on the ground. On the ground it is either by walking or by vehicle. The primary aerial patrol platform is a helicopter but in some instances a fixed wing aircraft is used. In both aerial and ground patrol there currently are electronic recording apparatus that are available for entry of information. But, most commonly, the data is gathered in form of hand written notes, analog tape recorded voice notes, and a combination of both. Data gathered in that manner requires manual transcription and, in applications where the data will be archived in asset management systems such as Maximo, Tamis or Smallworld, it must be converted to a digital format. These asset management systems are sometimes referred to as data warehouses.

The structures are usually catalogued by the utility by an identifier, e.g. a tower number, and can be identified by their respective geographic coordinates as well.

The disadvantages in the commonly accepted patrol modes are the potential for lost or misinterpreted information in the actual transcription of the notes, the time delay inherent in having to transcribe notes, and the potential for the gathered data to become stale if too much time elapses between the inspection and creation of the notes and the actual transcription and its incorporation in the asset management system. It is through the asset management system where in one form or another, e.g. work orders, the necessary action items and/or instructions are generated for follow up maintenance on the lines to correct defects, vegetation problems and the like.

There are available some handheld data entry assists which can be used but those, in comparison to attributes of this invention, are cumbersome to use, lack the features of flexibility and ease of operation, do not fully acquire and store and a readily retrievable manner the necessary information, and do not as closely approximate what can be done with hand written notes.

Among the objects of this invention is the provision a user friendly input system which stores data in digital form, in whatever format is desired by the utility, and in a manner that the stored data is readily retrievable from the data acquisition system for storage in asset management systems, GIS and/or for the generation of work orders either directly outputted from the stored acquisition unit or from the asset management system where it might be archived.

Among the more specific objects are to store the acquired data on structural defects, vegetation problems and the like in coordination with the utility's particular identifier of their support structures and with the geographical coordinates of the support structure; and to allow the observer to generate a voice note relating to the particular defect or vegetation problem or take a digital still picture of the defect and/or vegetation problem, with both the voice note and the digital picture being stored and retrievable in the same manner as the defect or vegetation entry, i.e. indexed to the particular support structure.

It is a further more specific objective to achieve all of the above features in essentially a compact equipment package that is readily adaptable to the patrol platform, e.g. a helicopter, and provides ease of use for the observer with a minimum of distraction from the primary purpose of visually observing the transmission lines and the right of way.

Another object of this invention is to provide the ability to record the inspection of a structure, or vegetation area, even if no defect or vegetation problem is found, again this capability is a part of the compact and readily adaptable equipment package mentioned above.

Still a further object of this invention is to provide, in the same basic package, the ability to accomplish a survey of the transmission lines, i.e. establish the geographic coordinates, longitude and latitude, of the support structures.

Yet another objective is to provide in the basic package the tools for accommodating data acquisition capabilities in a manner that permits executing multiple data acquisition tasks in the same aircraft flight to thereby leverage flight time.

### SUMMARY OF THE INVENTION

For the achievement of these and other objects, this invention proposes a system wherein the interface between the observer and data acquisition/storage is a touch screen through which commands for data recording are transmitted to a digital storage capability. Preferably this is a laptop computer with a touch screen but could also a monitor and data storage capability separate from monitor. These are all conventional, widely accepted equipment options and, in the following discussion, the preferred laptop configuration may at times be referred to as a CPU (central processing unit as that term is commonly understood in the field of hardware and software).

In accordance with this invention, the touch screen contains a number of buttons. Each button corresponds to a commonly encountered defect or vegetation management problem. As the observer detects a particular defect/vegetation problem he touches the corresponding button and the defect is stored in memory and is automatically synchronized with the structure at which the defect is found. In instances where the defect may be of a type where the severity may vary the touch screen is provided with means for entry the severity of the defect. For example, defects may be of the type that require immediate attention by a maintenance crews, require attention in time but not immediately and that time may vary. The observer can input the severity of the defect through touches on the screen and the severity will be recorded and included in the report in direct association with the identified defect/problem.

Further, the touch screen is provided with a visual indication for the observer of the helicopters position on a particular line and a specific indication of the actual structure which has been captured for data entry, along with past as well as upcoming structures. The system allows the observer to continuous fly by and enter data or to pause the data entry on a particular structure for more extensive data entry. The pause allows the observer to complete a data entry without the system leaving a particular structure for synchronization if extensive defects have to be recorded. The system will automatically return to the proper sequence of the structures in the flight plan after the pause is completed. This allows the observer to return to normal patrol sequencing of towers when he has completed the extraordinary defect entry.

The system allows the observer to generate voice notes should he find a defect or condition that he wishes to further document. The voice note is handled through the aircraft audio system and is digitally stored with the defect identification and is synchronized with (indexed to) the particular structure involved as well as the relevant defect entry on the touch screen.

The system also allows for taking of hand held photographs at the option of the observer. The photographs are in a digital format the same as the other stored data. When a photo is taken it is synchronized with (indexed to) the support structure which was captured by the system for data entry and is entered along with the detected defect, and voice note if one was entered. Where such a photo is taken it can become a part of the final report along with the other recorded data, i.e. archived in the asset management system data base.

The system also provides the capability for accurate data entry where multiple circuit lines are being patrolled.

Preferably and to make optimum use of available touch screen space, the structure/defect option is viewable on one screen on the laptop and the vegetation management option can be viewable on a second, separate screen on the laptop with means being provided to switch (toggle) between the two screens. The defect and vegetation options may be viewed on the same screen if the preprogrammed categories of each are of a number that permits that option. This combination of inspection categories allows one observer to combine and execute, in one flight, both the structure/defect patrol and the vegetation management patrol.

It will be recognized reference to “the system” is a shorthand way of referring to operational software which forms a-part of this invention and which is the processing media for achieving the various functions just described and those to be described.

Preferably the system utilizes the audio system of the aircraft for generation of the voice note.

The system will readily accommodate the various defects and vegetation problems likely to be encountered and will assemble the data acquired in a digital report. The digital report is readily assimilated, imported, into an asset management system of the utility's choice. If desired, it can generate an immediate hard copy work order for delivery to a maintenance crew containing print outs of conditions that require immediate attention, their location on the grid, and a copy of the still photo if one was acquired. Obviously, the work order also can be delivered electronically to the maintenance entity from the asset management system server.

The overall system, hardware and software, thus has the capability of providing for still images of defects as well as vegetation management problem situations that are synchronized to the structure at or in association with which they are found. In the case of vegetation problems these are associated as in the vicinity of if not right at the support structure. The system has the further capability of allowing the observer to record the general geographic coordinates of the vegetation problem per se with the use of the survey/record/locator capability of this invention. Again synchronizing the problem entry, a photo if taken and a voice note if entered.

The system also allows for positive identification of structures inspected (flown by) even if a defect is not detected and in such a manner that identification locates the structure flown by its geographic coordinates. This capability is identified as survey/record/locator consistent with the uses to which it can be put. This feature records all patrol activity to establish a record of the extent of the patrol of the transmission lines, i.e. the observer can use this capability to enter the coordinates of a support structure that is examined but for which no defect entry was made. It also affords the capability of providing survey data (survey in the sense of locating the support structures in the right of way by recording the geographic coordinates of structures). More particularly, the system hardware and software, has yet the further capability of providing a survey option. Survey in the sense of recording the geographic coordinates of transmission line structures, and other transmission line assets.

As a result of the make up of the system software there are other specific data acquisition options which flow from or can be programmed into this system. Those will be discussed in the following description.

A preferred embodiment of the invention will be described with reference to the following illustrations.

### DESCRIPTION OF THE DRAWINGS

FIG. 1, a touch screen representation of a defect entry system;

FIG. 2, a touch screen representation of the vegetation management system option;

FIG. 3, illustrates a situation where the utilities data base of existing structures is erroneous and the observer has encountered a structure that is not in the data base or, conversely, a structure in the data base that is in fact not on the line;

FIG. 4 illustrates a part of a screen used in executing the survey/record option of this invention, in practice this could be displayed as part of basic touch screen, FIG. 1 or can be a separate screen;

FIG. 5 illustrates the set up for the digital still photo capability of this invention;

FIG. 6 illustrates the touch screen for defect entry on a multiple circuit line;

FIG. 7 is a further illustration of another aspect of the defect entry on a multiple circuit line; and

FIG. 8 illustrates a part of a screen used in exporting the acquired data to a repository external to lap top.

### DESCRIPTION OF THE PREFERRED EMBODIMENT

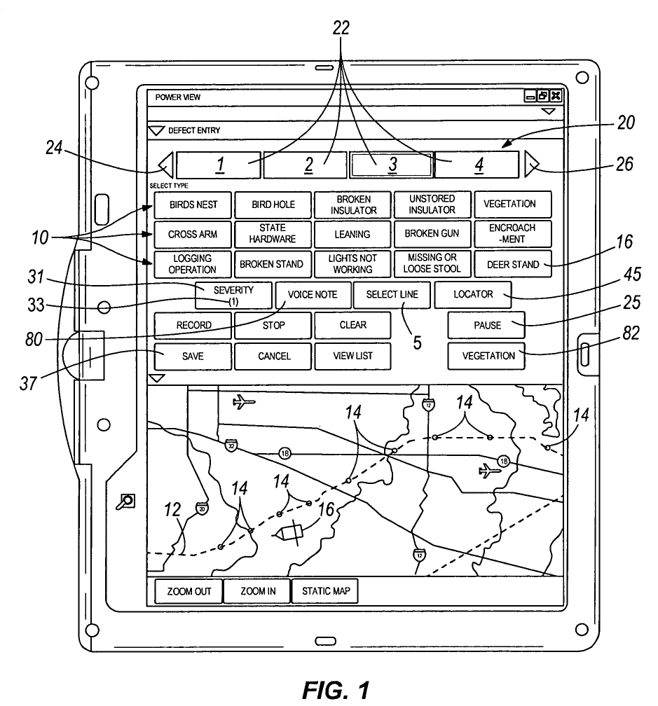

This invention can be executed by traversing the grid, i.e. moving along the transmission lines and the right of way, in any manner but preferably is with a helicopter as the patrol platform. The invention can utilize any form of central processing unit (CPU) with a touch screen capability (a touch screen monitor connected to a CPU) but is preferably carried out using a conventional rugidized laptop with touch screen capability such as Rugidized Toshia Pentium M 753 1.2 GHZ ULV, the touch screen portion of which is depicted in FIG. 1. The laptop is preferred because of ease of use. The observer can carry on and off the aircraft and no additional equipment need be associated with aircraft other than the GPS unit.

For the GPS capability to be associated with laptop and the ability of the laptop/CPU to function on the basis of geographic coordinates inputed to CPU and to record GPS coordinates of structures during fly by reliance is placed on U.S. Pat. No. 7,184,072 B1. The description of that issued U.S. patent is hereby incorporated by reference in this application.

The GPS can be either mounted on the aircraft in a conventional or can be provided internal the laptop.

As is explained in the above referenced letters patent, the coordinates (geographic coordinates by Longitude and Latitude) of all the structures for all of the lines of a utility user are loaded into memory of the laptop at least those which relate to a particular flight plan. These inputted coordinates are hereinafter referred to as the transmission line data base. The line data is stored by whatever designator the utility wishes to use for its various transmission lines, town to town, substation to substation, or the like, e.g. the heading in FIG. 1 “CLARKSVILLE SUB #327 to FISHERS N”.

Prior to the start of an inspection the observer accesses the transmission line data base stored in the laptop memory and selects the particular lines to be inspected that day. That sets up the flight plan for that day. This is done by touching a “select line” button 5 in FIG. 1. In response, a drop down menu appears with all of the stored lines arranged by the above mentioned designator. The Observer selects the lines to be patrolled and touches an appropriate enter button on the drop down and those lines are stored for the patrol thereby establishing the flight plan for the patrol to be executed that day, or that week as the case may be.

The screen has a plurality of buttons 10 as shown in FIG. 1. Each corresponds to a different defect as might be expected to be encountered on a transmission line being inspected. As is visible in FIG. 1 the defects are labeled “Birds Nest”, “Bird Hole”, “Broken Insulator”, “Cross Arm”, etc. A map is displayed below the button portion of the screen. The relative positions of the button area and the map may be varied on the screen, e.g. map in the left half and the buttons on the right half. The map displays the terrain over which the patrol is being executed and the dotted line 12 is the line being inspected. The structures on the line appear as larger dots 14. 16 is a moving representation of the helicopter as it flies along the line. This gives the observer a visual of the line being patrolled and his exact location on the line on a real time basis.

As the helicopter approaches one of preprogrammed flight plan lines that line will appear as the dotted line 12 and its designator will appear in the heading, “CLARKSVILLE . . . FISHERS N” or the like. The operational software coordinates the transmission line data base with the onboard GPS such that representations 14 of the transmission line structures appear on the map in accordance with their geographic position based on the geographic coordinates that had been previously programmed into memory.

The structure indicators in advance of the helicopter flight path appear on the map in one color, the structure in range and being inspected will appear in a different color, and once the helicopter has passed a structure and it is no longer is in range it will appear on the screen in yet a third color indicating that it has been inspected.

A bar 20 extends across the top of the screen. It has a plurality of rectangular areas 22. Arrows 24 and 26 at the opposite ends of the bar correspond to serial movement of the helicopter past the structures, 26 in the direction of flight and 24 opposite to the direction of flight. The areas 22 are numbered in sequence using the utility's indicators for its structures, e.g. structure numbers. In the illustration, the numbers are arbitrarily chosen as 1, 2, 3, and 4. 1, 2, and 4 are the same color and 3 is highlighted. The system highlights 3 as the structure in range and under inspection. By in range is meant that the structure is within a predetermined distance of laptop, and correspondingly or in other words from the helicopter on which the laptop is carried. When structure 3 it is captured in laptop, and thus highlighted so the observer knows it is captured. Any defect entered by observer will be referenced in memory to that particular captured structure. Any other entries while the structure is in range, i.e. captured, will also be indexed to that structure, e.g. photo, voice or locator discussed hereinafter. All entries through the touch screen will be indexed to the captured structure and stored in memory together in that manner and for retrieval together for reporting in a desired format.

In this example structures 1 and 2 will have already been inspected and any defects entered will have been similarly referenced, indexed and stored. The screen shows the observer that structure 4 is coming up as the next structure to be observed. When the helicopter has moved a preselected distance relative to structure 3 toward structure 4, 3 will be out of range and no longer captured/highlighted and structure 4 will come into range be highlighted and captured for defect entry and reference of any defect entries to structure 4. In actuality, area 4 will replace area 3 in the position shown in the bar so the observer has a real time visual indication of where he (the helicopter) is at all times on the line. An area 5 will replace area 4 and area 1 will disappear from the bar. The structure numbers will sequentially appear in the bar as the flight progresses and until the entire transmission line has been flown and inspected.

By reference is meant that the acquired data will be stored in memory in the CPU by its structure designator and geographic coordinates. At the end of day, or at whatever interval the utility wishes to download the acquired data, the data is retrieved by structure number and geographic coordinates and the associated, previously entered defect.

Efficient patrol strives for a consistent air speed continuously along the line, although it is possible to back track to and/or hover at structure. To accommodate the consistent air speed goal the system has the capability of allowing the observer to lock onto a structure, i.e. pause the system on that structure, in the event multiple defects have to be entered and more entry time is needed than what is available while the structure is in range. The operational software pauses at the current structure in range that requires additional time and allows entries to made, defects to be entered, and indexed to the paused structure as the helicopter proceeds down the line and even though that structure is no longer in range. The system continues to register the coordinates of the structures being flown past so that when the observer terminates the pause the next structure in sequence will be locked on for defect entry. For example, if the system is “paused” on structure 3 by touching pause button 25, then when the pause is ended by again touching button 25 the system will treat structure 4 as the structure in range so far as data entry is concerned. The observer can enter any defect observed during the pause on structure 4 and it will be archived in the same manner as explained above, i.e. structure 4, geographic coordinate and defect type. This will continue for structures 5, 6, and on until the system catches up in real time.

The system gives the observer the capability of toggling forward through the structures appearing in bar by touching button 26 and going backward by touching button 24. Thus if no additional defects were observed during the pause the observer can toggle to the current structure and return quickly to a real time flight situation. Similarly, if the observer wants to modify the entries on a structure which has been flown by he can toggle back to that structure and any modification is indexed to the structure he highlights.

The defect entry screen and the system include the capability to enter the severity of the condition detected. A severity button 31 will respond to touches and call up a number in parenthesis 33. Repeated touches will change the number in parenthesis from 1-5 and when the appropriate number has been selected the observer touches button 37 to execute a save. The severity, 1 for lowest priority and 5 for highest, is logged in/and indexed with the other entered data and can be retrieved with the other recorded data for inclusion in the work order to indicate to the maintenance crew the urgency or lack thereof in doing corrective maintenance. The system can be programmed to use whatever severity indicator the utility wishes. The severity entry can also be used to determine when a work order need be generated.

The screen gives the observer an indication on real time helicopter position as result of color differentiation described above.

On occasion the utility's available data base of structures and coordinates is not complete or contains an error such that the observer will encounter a structure that is not in the data base, a new structure, or will be at location where the data base says a structure should be present and it is not. In that situation, the observer can call up a screen, or an area on the defect screen, indicative of operational software that allows the observer to enter that structure as a new structure or make an entry that a structure is missing.

In the case of a new structure, he can enter a designator, label the structure as new and, optionally, activate the locator, which will be described later, to enter the geographic coordinates of the so called new structure. In the case of a missing structure he makes an entry at the geographic coordinates where the structure was indicated to be in the data base to the effect that the structure is missing.

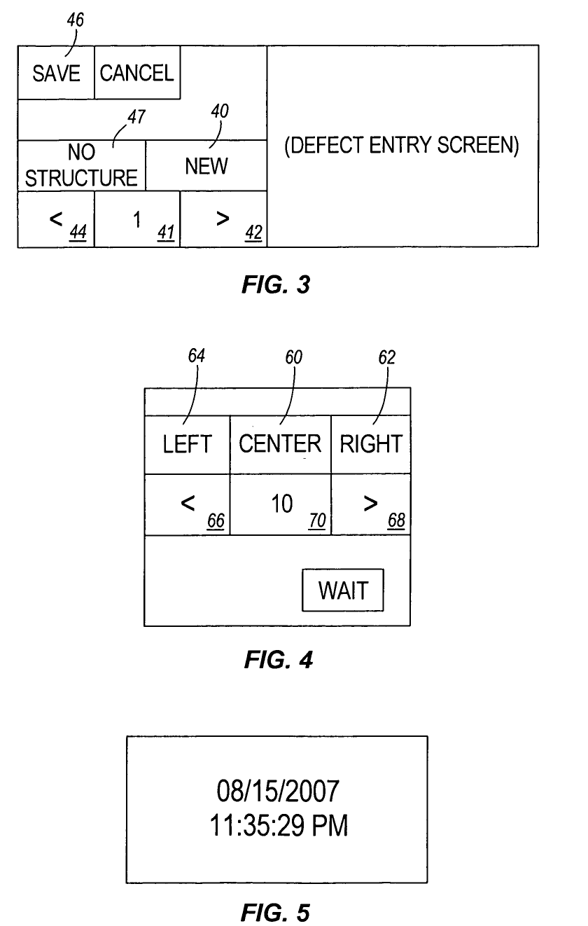

For example and with reference to FIG. 3, the buttons of the called up screen or portion thereof will have a button “new” 40, a designator area 41, with scroll buttons, forward 42 and back 44. The observer scrolls to the designator he wishes and when there touches save button 46. The data stored will be the geographic coordinates detected by the locator, the inputted structure identifier and the designation “new”. The operational software functions as well to give the observer access to the defect entry buttons in the area to the right of the rectangle within which the just mentioned buttons are located. Therefore, if a defect was observed on the “new” structure the appropriate button is touched and that defect is stored in synchronization with the just mentioned designator, geographic coordinates and the designation “new” in archived data. The defect entry portion of the screen is not shown in FIG. 3 as it will be the same as that of FIG. 1.

With further reference to FIG. 3, an entry button 47 is provided adjacent the “new” button 40 and when activated records the geographic coordinates, the structure designator for archived but missing structure, and records it as “missing”.

It is common practice for utilities to periodically survey their transmission lines to identify and locate, again by geographic coordinates, their structures. This is to verify the location of their assets. These surveys will vary in accuracy from single digit meter accuracy to sub meter accuracy depending on the manner in which the survey is conducted. The manner in which it is conducted can vary from on the ground with hand held locators to aerial surveys.

A survey capability is part of this overall system. This feature takes advantage of the GPS unit which is part of the system and the CPU having the capability to recognize and record geographic coordinates as the helicopter is flying along a line. To execute this feature an activator is included with the system. For example, this can be a button 45, also labeled “locator”, on the screen (FIG. 1). When touched the system will record and store the geographic coordinates of the structure in range at that time. The touch screen button could be replaced with a hand held actuator or foot actuated pedal.

The button is operatively connected to the operational software. Either button 45, a hand held actuator or the foot pedal and is operatively connected to the laptop, or CPU, in a conventional manner, for the hand actuator or foot pedal a suitable wired connection to a port, wireless, etc.

When the observer flies by a structure he touches the button 45 and the system records the geographic coordinates of the structure, more specifically the geographic coordinates of the laptop/helicopter on which the laptop is carried. A screen associated with this operation is illustrated in FIG. 4. This screen illustrates the set up for this survey capability in that it contains blocks which correspond to the orientation of the helicopter to the transmission line, center line 60 (directly over the line) and right 62 or left 64 of the line. The observer inputs that orientation by touching the appropriate button. If it is either left or right of the line he can input the offset of the helicopter right or left of line in feet or meters as the case may be. Below buttons 60, 62 and 64 are three additional operational buttons, arrow buttons 66 and 68 and display area 70. The observer selects left or right to input the flight orientation relative to line. He then scrolls either button 66 or 68 until the distance from the line appears in display box 70. An algorithm is included in the operational software that automatically corrects the inputted data. That is, touching button 45 will record the geographic coordinates of laptop or in other words the helicopter. The observer will touch the button when he is either over or directly along side of the structure. The algorithm empirically arrives at the actual geographic coordinates of the structure by converting the coordinates based on the offset. This conversion can alternatively be done in post processing of the acquired survey data using the geographic coordinates generated by touching locator button 45 and the offset information (FIG. 4) which is stored with those geographic coordinates.

This survey capability has an added use. It will record the fact that a structure was inspected even if no defect is entered. More particularly, the entry of a defect records the fact that that structure was inspected. If a defect is not entered, there would not be a record of the inspection. With this locator/survey feature the observer can activate the locator at each structure or just at those structures where a defect was not entered. This establishes a record of the fact that a structure was inspected.

The survey results of this feature are not as accurate as other survey techniques but in many cases it is a reasonable trade off of accuracy and cost.

An additional capability of this system is the ability of the observer to take a digital, still photo of a defect condition and have it recorded in synchronization with the other defect entered data. A digital camera (not shown), hand held or otherwise capable of being aimed at a defect, is operationally connected with the laptop/CPU, e.g. wireless or suitable hard wire connection to an appropriate port on the laptop. When the observer is in range of a structure as discussed above and is entering a defect he can he can elect to take a photo of the defect condition. That photo will be recorded and associated with the other acquired data with specific reference to that particular, captured structure. The photo can be downloaded in the desired report format at the end of the flight, or flight if it is longer than one day, along with the defect related entered data so that all are together in the report format.

More particularly and with reference to FIG. 5, the digital camera has a date, time indicator as does the laptop. Before initiating the flight the observer calls up a date, time page incorporated in the laptop, the internal clock of the laptop and displayed in FIG. 5. This page displays the date and time in real time. The observer takes a picture of that page with the digital camera. The camera has its own date and time capability that is embedded on the photo. This records a comparison between the computer date/time and that of the camera, more particularly establishes the time offset between the camera time and the computer time if one exists. When a still picture is taken of a structure in the course of a patrol the date and time of the picture is logged in association with the picture. The system logs the start and end times for a structure being in range for defect entry purposes. Those start and end times are recorded as part of the captured data. In post processing, the acquired data for a particular structure will be retrieved and that will include an indication that a still photo was taken. The start and end times will also be noted with that retrieved data. The start and times of structure in range are identified and compared to camera time and the initially observed time offset between camera and computer. With that information and knowing the initially established time between the camera and the laptop date and time mechanism, the structure having the defect can be identified and the photo pasted into the recorded data along with the other stored defect information. Pasted in the sense that it is archived along with the other acquired data as explained above.

Yet another capability of the system is the acquisition of voice notes for a defect and recorded with the defect entry in specific reference, indexed, to a particular structure, and the photo if taken. To this end the observer is provided with a micro phone that is connected in the helicopter audio system operationally to the laptop. The basic defect entry screen includes a button 80 that allows the observer to selectively activate the system to record a voice note. This voice note will be archived with other data entered for the structure that is in range, i.e., referenced/indexed to the structure in range and archived appropriately with the other data acquired relative to that structure.

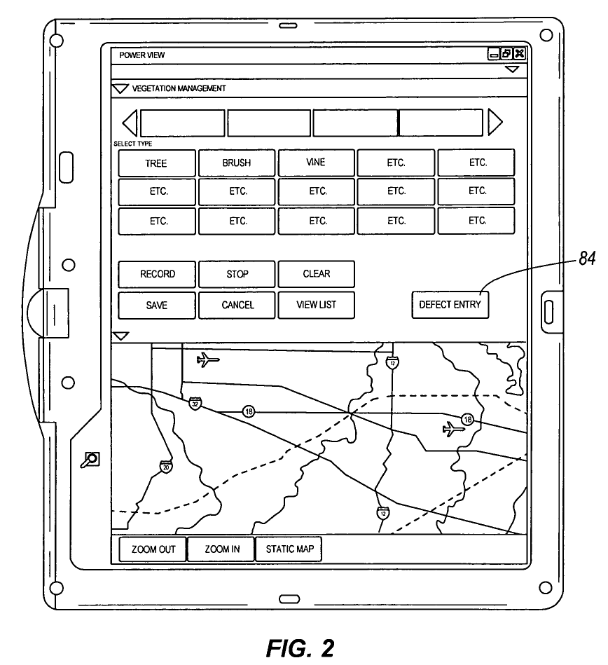

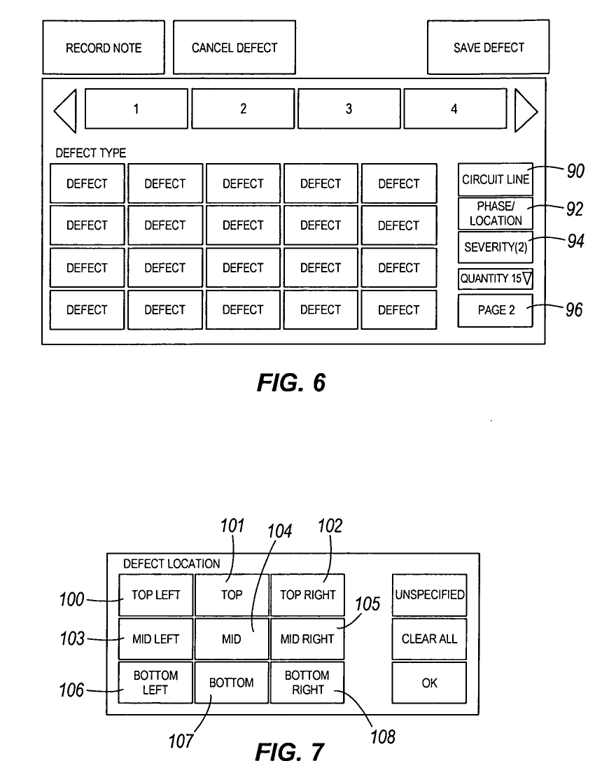

Having described the defect entry system there is another operational feature of this overall system, namely vegetation management. Vegetation management is another regular inspection activity along with transmission line patrols. The core operational capability of this system includes the alternative of vegetation management, in the same laptop for executing the defect entry operation, to enhance the acquisition of data in the course of vegetation inspection. A second basic screen, FIG. 2, is provided which is visually similar in most respects to the defect entry screen except for the fact that the defect buttons are replaced with buttons corresponding to vegetation situations that require attention to maintain the integrity of the transmission lines. These are illustrated in FIG. 6 with the labels “tree”, “brush”, “vines”, etc. The system allows the observer to toggle between the defect screen and vegetation management screen.

As seen in FIG. 1, button 82 is labeled vegetation. When button 82 is touched the screen switches to that of FIG. 6 and the observer can touch input observed vegetation situations. The same as in the defect entry option that input will be referenced to the structure in range and associated with it by structure designator and geographic coordinates. The ability to enter severity is the same as with defect entry as is the ability to associate a voice note and a digital photo. The advantage here is vegetation management can be combined with defect patrol. One observer can execute both functions. Or, two observers each having laptops can fly the mission one doing defect entry and the vegetation situation entry. When the screen is switched from defect entry to vegetation management a button 84 appears on the vegetation screen labeled Defect Entry. The observer can change back to defect entry by activating that button. In this manner the single observer, when a single observer is used, can toggle between defect entry and vegetation situation entry.

As an example of the versatility of the system is a feature which provides detailed entry of defect data for multiple circuit lines. Multiple circuit lines are ones which incorporate a plurality of lines, for example nine lines with corresponding nine support points on a particular structure.

More particularly, FIG. 6 is a diagram representing an alternative defect entry screen. In order to accommodate the new functionality, four additional buttons 90, 92, 94 and 96 have been added on the right hand side of the defect entry screen of FIG. 1. The basic defect entry screen of FIG. 1 will include a button corresponding to a multiple circuit line. The operational software/flight plan will alert the observer that he is approaching a multiple circuit line and identify that line for him. He will touch the multiple circuit line button 90 and when the helicopter is in range of that line it will make available the geographic coordinates of the structures of that line as explained above in connection with the basic defect entry operation.

The uppermost button 90 permits setting the number of circuits that are being dealt with, 1 through 3 circuits. The number, 2, in parenthesis can be varied by touching and holding the button until it reaches 1, 2 or 3, the number of circuits in this example. That presets the defect entry system for multi circuit defect entry.

Button 92 when touched toggles to the schematic circuit screen of FIG. 7. The screen of FIG. 7 contains nine buttons 100-108 corresponding to left top, center and bottom, center top, center and bottom and right top, center and bottom. These correspond to connection points of each circuit on structure. Button 94 is a severity button with the number in parenthesis designating the severity of the defect which determines the attention that should be given to the defect repair, 1 for immediate attention up through any desired series of numbers as preferred by utility to the least problematic which can have attention in due course as dictated by the need to address other tasks. This is identical to severity option discussed in relation to basic defect entry option.

This severity button is provided and functions in the same manner as that with the basic defect entry screen both with respect to recording/archiving acquired data and retrieval thereof for work order generation.

In operation, the observer is prompted by the basic touch screen that he is approaching a multi circuit line in response to which he toggles to multi circuit screen FIG. 6. If a defect is observed he touches the appropriate defect button and brings up FIG. 6 at which point he touches the one of the nine location buttons 100-109 that corresponds to the location of defect. He touches the OK button 110 for a save function and the acquired data goes into memory. He returns to the main screen, FIG. 6. He can enter the severity either before he goes to FIG. 7 or after he returns to FIG. 6.

More particularly, the functionality just described allows the observer to identify the number of circuits on each structure. The ‘Circuits’ button 90 is on the basic defect entry screen, FIG. 1. By default, this button will not be selected (i.e. indicating a single circuit). When the observer is prompted, or notices that they are flying a multi-circuit line, he may click on the button to toggle it to the proper number of circuits (1, 2, or 3). The number of circuits indicator value shall be stored with the structure marking information. Once selected to indicate 2 or 3 circuits, the value will remain until it is changed. When the Circuits selection is set to 1, the defect entry will behave in its normal manner. When the circuit selection is set to 2 or 3, when a defect type is clicked, the operator will be prompted to specify the defect location as described above in connection with FIGS. 6 and 7. The location selection will be used during the post processing to identify the actual line on which the defect occurred.

As part of the defect entry selection, when a multi-circuit line is identified (by the operators selection of the Multi-Circuit button mentioned above), the operator can be automatically prompted to specify the location of the defect. The location selection allows mapping the defect to the proper line as part of a post-processing effort.

The defect entry allows the observer to specify the Phase/Location of a defect after the defect type is selected. This is a feature that can be either always on or always off or it can provide that the observer can specify when the defect ‘Phase/Location’ is specified. After clicking on a Defect Type, the operator can then click on the ‘Phase/Location’ button to have the Location selection options displayed.

The defect severity button allows the operator to specify the severity of a defect. The severity will pertain to the last defect type clicked on. By default the severity will be 3-Low. Clicking on the button will toggle the value from 3-Low, to 2-Med, to 1-High.

A new ‘Line Complete’ indicator is provided to the line selection list to assist the operator in identifying which lines have been completed. On the line selection list (button 5), a button allows the operator to mark a line as completed. This status shall be displayed in the line list next to the line name. A filtering option is also available allowing the operator to hide completed lines from the list of lines in the flight plan or in the transmission line data base.

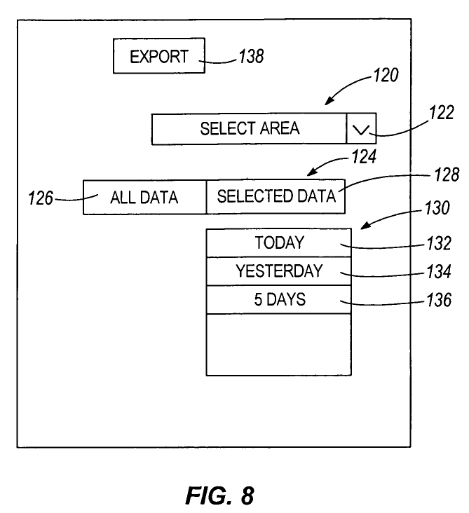

The system of this invention also includes an export or reporting screen, FIG. 8. This is a separate screen or part of a larger screen. It includes a selection bar 120 with a drop down button 122. Touching button 122 brings up all of the lines, areas that have been patrolled. A particular line can be selected. Bar 124 has two buttons 126 and 128. Touching button 126 will access all data for the line selected under bar 120. Touching button 128 will produce a drop down menu 130 allowing selection of data for the selected line for that day, if the export is done at the end of patrol on a given day, button 132. Button 134 accesses the data acquired the previous day (yesterday). Button 136 allows access to data for the past five days of patrol. These are merely examples of time increments within which acquired data can be accessed. Once accessed the data, via conventional connections fire wire, wireless, etc. the data is exported to an external storage point or directly to an asset management system such as Maximo, Tamis, or the like. This is executed by touching export button 138 after all of the above set up steps have been taken.

What is claimed is:

1. A system for recording unwanted conditions along an electrical transmission grid which extends over a defined right of way and as an observer traverses the grid and right of way, said system operating through a central processing unit which central processing unit includes hardware and operational software capable of storing both input operational data and data acquired in the course of said traverse and having a touch screen interface through which an observer can access input operational data so stored and through which the observer can input new data observed as the transmission grid is inspected in the course of said traverse and said system also operating in association with a GPS capability, said system comprising the steps of
providing the touch screen with multiple button areas corresponding to the unwanted conditions expected to be observed during the traverse,
inputting and storing to memory geographical coordinates corresponding to known locations of support structure in the grid to be inspected, and through cooperation of the stored geographical coordinates, the GPS capability and the central processing unit,
capturing a given support structure for data entry when said given support structure is within a preselected distance of the central processing unit such that any data entered through the touch screen is stored as a condition corresponding to area touched and that entry being indexed to the captured support for later retrieval from storage,
a support structure remains captured so long as the support structure is within said preselected distance from said central processing unit and, as the traverse proceeds from one support structure to another, a previously captured support structure is released when said predetermined distance is exceeded and another support structure is captured when it comes within said preselected distance from said central processing unit for said data entry as set forth in the immediately preceding paragraph, and
providing means for downloading said data entered to central processing unit memory to a preselected reporting media.

2. The system of claim 1 including accessible on said touch screen areas responsive to touches for entering degrees of severity related to the conditions of conditions entered for said captured structure.

3. The system of claim 1 including providing means operatively associated with said central processing unit and said GPS and selectively operable by said observer to determine the geographic coordinates of the central processing unit at any given time during the traverse relative to an adjacent support structure and including means for inputting the position of the central processing unit relative to said adjacent support structures to an algorithm for translating said central processing unit inputted position to the location of the adjacent support structure whereby traverse and the geographic coordinates of that adjacent support are stored in memory for later retrievable in report form.

4. The system of claim 3 wherein the means for determining the geographic coordinates of said central processing unit is initiated by a corresponding area on said touch which when touched activates the GPS and the operative software to input the location of the central processing unit at the time of said touch into central processing unit memory in the form of geographic coordinates translated by said algorithm.

5. The system of claim 4 wherein the means for determining the geographic coordinates of said central processing unit is initiated by a corresponding area on said touch which when touched activates the GPS and the operative software to input the location of central processing unit at the time of said touch into central processing unit memory in the form of geographic coordinates translated by said algorithm.

6. The system of claim 5 wherein means is provided for inputting the orientation of the central processing unit relative to the line being traversed during the traverse, either center line on the transmission line or left of right of transmission line and further for inputting the distance of the central processing unit right or left of the transmission to memory for computation within the algorithm.

7. The system of claim 6 wherein means is provided for recording the presence of a structure not in the originally inputted structure data base and also for recording the absence of a structure noted in the structure data base as at a particular geographic position but not at that location.

8. The system of claim 1 providing means operatively associated with said central processing unit and said GPS and selectively operable by said observer to pause the system on a currently captured structure so that it remains captured as said central processing unit exceeds said predetermined distance said central processing unit is further programmed to serially capture subsequent structures as the traverse of the transmission line continues while simultaneously maintaining proper sequencing of structures traversed during the pause and after the pause is terminated presenting the so sequenced structures on the touch screen for said data entry and indexing to the proper structure.

9. The system of claim 8 including providing means accessible from said touch screen for scrolling through the structures serially captured during the pause to accelerate return of system a real time condition at the transmission line and for scrolling back to a previously captured structure to allow revision of an entry made on that previously captured structure.

10. The system of claim 1 providing stored circuit visual representations capable of being selectively displayed on the touch screen, said stored circuit visual representations corresponding to multiple circuit orientations to be encountered on a support structure as said traverse progresses, means operable by the observer on the touch screen for displaying said circuit visual representations on the touch screen which when touched will record in memory the circuit position of the defect on the support structure so that both the defect type and its position on the structure are recorded.

11. The system of claim 1 providing digital still camera means for selectively taking a photo of a condition, said camera means operatively associated with said central processing unit to store said photo in memory indexed to said captured with other condition entries made for that captured structure.

12. The system of claim 11 including indexing said camera means with said central processing unit memory storage by taking a photo of the internal clock of the central processing unit to establish the time offset between the central processing unit clock and the clock of the camera means for subsequent retrieval of photos for reporting.

13. The system of claim 12 including logging the internal central processing unit start and end times for capture of a structure and recording said start and end times indexed along with other entered data, and reporting said start and end times with other entered data for retrieval of photos.

14. The system of claim 1 including providing voice note means for selectively generating a voice note of a condition, said means operatively associated with said central processing unit to store said voice note in memory indexed to said captured structure with other condition entries for that condition for that captured structure.

15. The system of claim 1 wherein the conditions programmed to memory in the central processing unit are defects and condition representations on the touch screen are defect types.

16. The system of claim 1 wherein the conditions programmed to memory in the central processing unit are vegetation conditions and condition representations on the touch screen are vegetation conditions.

17. The system of claim 1 wherein said touch screen includes two selectively displayable screens one related to defects for defect entry and the other related to vegetation effect condition screen, means operable from the touch screen for selectively displaying said defect condition screen, said vegetation condition screen, and both said defect and vegetation condition for selective data entry of defects and vegetation conditions.

18. The system of claim 1 wherein said central processing unit is a laptop computer.

19. The system of claim 1 wherein said system is executed for a helicopter.

20. The system of claim 1 wherein the entered data is stored relative to duration of duration of the traverse of the transmission lines and is selectively retrievable as all data entered and data retrieved over particular time frames and wherein in reporting said central processing system displays a menu for selection of the desired reporting options.

21. A system for recording from an aircraft the position of a structure which is part of an electrical transmission grid which extends over a defined right of way and as an observer traverses the grid and right of way, said system operating through a central processing unit which central processing unit includes hardware and operational software capable of storing data acquired in the course of said traverse and said system also operating in association with a GPS capability, said system comprising the steps of
providing means operatively associated with said central processing unit and said GPS and selectively operable in conjunction with said GPS by said observer to determine the geographic coordinates of the central processing unit at any given time during the traverse relative to an adjacent support structure and including means for inputting the position of the central processing unit relative to said adjacent support structures so determined to an algorithm for translating said central processing unit inputted position to the location of the adjacent support structure whereby the geographic coordinates of that adjacent support are stored in memory for later retrievable in report form.

22. The system of claim 21 wherein the means for determining the geographic coordinates of said central processing unit is initiated by a corresponding area on said touch which when touched activates the GPS and the operative software to input the location of central processing unit at the time of said touch into central processing unit memory in the form of geographic coordinates translated by said algorithm.

23. The system of claim 21 wherein means is provided for inputting the orientation of the central processing unit relative to the line being traversed during the traverse, either center line on the transmission line or left of right of transmission line and further for inputting the distance of the central processing unit right or left of the transmission to memory for computation within the algorithm.

24. A central processing unit including memory capability and operational software in combination with a touch screen and a GPS unit,
said central processing unit programmed to store known, preselected geographic coordinates of structures making up a part of an electric transmission line and programmed with said GPS unit to enter geographic coordinates for the central processing unit upon command whereby said central processing unit is preloaded with the geographic coordinates of the structures in an electric transmission line,
said touch screen provided with multiple button areas corresponding to the unwanted conditions expected to be observed during traverse of a transmission line and its associated right of way, and said buttons being interactively programmed to enter into the central processing memory a record of the condition corresponding to that ascribed to the button when the button is touched,
said touch screen including accessible areas responsive to touches for entering degrees of severity related to said unwanted conditions, and
said central processing unit programmed to capture a structure by responding to the presence of a structure by its geographic coordinates when said structure is within a preselected distance of said central processing unit and further programmed to enter into memory any condition entries through said touch screen while within said preselected distance in association with the identity of the captured structure, said central processing unit releasing said captured structure when no longer within said preselected distance whereby said central processing can be moved along the transmission line and right of way and will capture and release the structures in the order they are located in the transmission line.

25. The central processing unit of claim 24 wherein said central processing unit is programmed so that the serial capture and release of structures can be paused to maintain the capture of a particular structure when said preselected distance is exceeded and entries can be made to memory during the pause in association with the identity of the captured structure,
said central processing unit is further programmed to serially capture subsequent structures as the traverse of the transmission line continues and upon termination of the pause to return to the structures captured during the pause starting with the structures next in line in the transmission line to that at which the pause was initiated for additional entry of conditions to memory, and
means accessible from said touch screen for scrolling through the structures serially captured during the pause to accelerate return of system a real time condition at the transmission line.

26. The central processing unit of claim 24 wherein said central processing unit is programmed to include the configuration of the circuits to be encountered as the transmission line goes from a single circuit line to a multiple circuit line and means accessible through the touch screen and in conjunction with the stored geographical coordinates for displaying the configuration of the circuit with the circuit positions being arrayed in touch sensitive areas operative when touched to record in memory the position of a condition in the circuit configuration.

27. The central processing unit of claim 24 including voice note entry means associated with the central processing unit and programmed therewith to enter into memory an explanatory note of a condition entered for a captured structure and that voice not being stored in memory in association with the identity of the captured structure along with the condition entry so that the condition and voice note are retrievable together for reporting.

28. The central processing unit of claim 24 including digital still camera means associated with the central processing unit and programmed therewith to enter into memory a photograph of a condition entered for a captured structure and can be stored in memory in association with the identity of the captured structure along with the condition entry so that the condition and photograph are retrievable together for reporting.

29. The central processing unit of claim 28 including means indexing said camera means with said central processing unit memory storage by taking a photo of the internal clock of the central processing unit to establish the time offset between the central processing unit and the camera means for subsequent retrieval of photos for reporting.

30. The central processing unit of claim 29 including means for logging in the internal central processing unit the start and end times for capture of a structure, means for recording said start and end times indexed along with other entered data, and means for reporting said start and end times with other entered data for retrieval of photos.

31. The central processing system of claim 24 including providing means operatively associated with said central processing unit and said GPS and selectively operable by said observer to determine the geographic coordinates of the central processing unit at any given time during the traverse relative to an adjacent support structure and including means for inputting that position of the central processing unit relative to said adjacent support structures to an algorithm for translating said central processing unit inputted position to the location of the adjacent support structure whereby the geographic coordinates of that adjacent support are stored in memory for later retrievable in report form.

32. The central processing system of claim 31 wherein the means for determining the geographic coordinates of said central processing unit is initiated by a corresponding area on said touch which when touched activates the GPS and the operative software to input the location of the central processing unit at the time of said touch into central processing unit memory in the form of geographic coordinates translated by said algorithm.

33. The system of claim 31 wherein means is provided for inputting the orientation of the central processing unit relative to the line being traversed, either center line on the transmission line or left of right of transmission line and further for inputting the distance of the central processing unit right or left of the transmission to memory for computation within the algorithm.

34. The central processing system of claim 24 wherein means is provided for recording the presence of a structure not in the originally inputted structure data base and also for recording the absence of a structure noted in the structure data base as at a particular geographic position but not at that location.

35. The central processing system of claim 24 wherein said central processing unit is a laptop.
